(19) United States
(12) Patent Application Publication
(10) Pub. No.: US 2004/0126582 A1
(43) Pub. Date: Jul. 1, 2004

(54) Silicon nanoparticles embedded in polymer matrix

(75) Inventors: Kwok Ng, Austin, TX (US); Igor Pavlovsky, Austin, TX (US)

Correspondence Address: Winstead Sechrest & Minick P.C., P.O. Box 50784, 1201 Main Street, Dallas, TX, 75250-0784, US

(73) Assignee: Nano-Proprietary, Inc., Austin, TX

(21) Appl. No.: 10/645,022

(22) Filed: Aug. 21, 2003

Related U.S. Application Data
(60) Provisional application No. 60/405,616, filed on Aug. 23, 2002.

(51) Int. Cl. B32B 5/16; B32B 9/00

(52) U.S. Cl. 428/403; 428/407

(57) ABSTRACT

An organic polymer is used to disperse nanoparticles, such as silicon nanoparticles. The polymer matrix separates the silicon nanoparticles from each other, thus preventing them from aggregating to form clusters. The resulting silicon nanoparticles can then photoluminescence at the desired wavelengths. Such a polymer matrix with evenly dispersed silicon nanoparticles can also be used within a solar cell to increase the efficiency of such solar cell.

### CROSS REFERENCE TO RELATED APPLICATIONS

The present invention claims priority to U.S. Provisional Application Serial No. 60/405,616.

### TECHNICAL FIELD

The present invention relates in general to silicon nanoparticles, and more particularly to silicon nanoparticles embedded within a polymer.

### BACKGROUND INFORMATION

Robust, highly crystalline, silicon (Si) nanoparticles exhibit bright, visible photoluminescence when they are disbursed in an organic solvent such as hexane or chloroform. The color (wavelength) of the photoluminescence can be controlled by controlling the size of the Si nanoparticles. These nanoparticles, however, aggregate upon drying to form larger clusters, thus exhibiting a different photoluminescent color compared to that exhibited by the Si nanoparticles within the liquid solvent. This aggregation-caused behavior is a detriment to the use of Si nanoparticles being used in applications such as displays or quantum dot lasers, which require such materials to be in a solid form. FIG. 1 illustrates this problem where Si nanoparticles 102 are dissolved within solvent 101 and placed on a substrate 103 to form the desired device 100. Such Si nanoparticles 101 will exhibit a desired photoluminescent color, such as when irradiated with ultraviolet (UV) light. However, after the solvent is evaporated in step 104, the Si nanoparticles 102 will aggregate into clusters on the substrate 103. When then irradiated with energy, such as with UV light, such aggregated Si nanoparticles 102 will now exhibit a different photoluminescent color, which may be undesired.

As a result, there is a need in the art for a process for creating photoluminescent nanoparticles having a desired photoluminescence that is consistent during the manufacturing process.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a prior art process resulting in aggregated nanoparticles;

FIG. 2 illustrates a process in accordance with an embodiment of the present invention;

FIG. 3 illustrates electronic states in silicon nanocrystals as a function of cluster size;

FIG. 4 illustrates pixels of a display created using silicon nanoparticles in accordance with an embodiment of the present invention;

FIG. 5 illustrates a solar cell configured in accordance with an embodiment of the present invention;

FIG. 6 illustrates an alternative embodiment of a solar cell configured in accordance with an embodiment of the present invention; and

FIG. 7 illustrates a display apparatus configured in accordance with an embodiment of the present invention

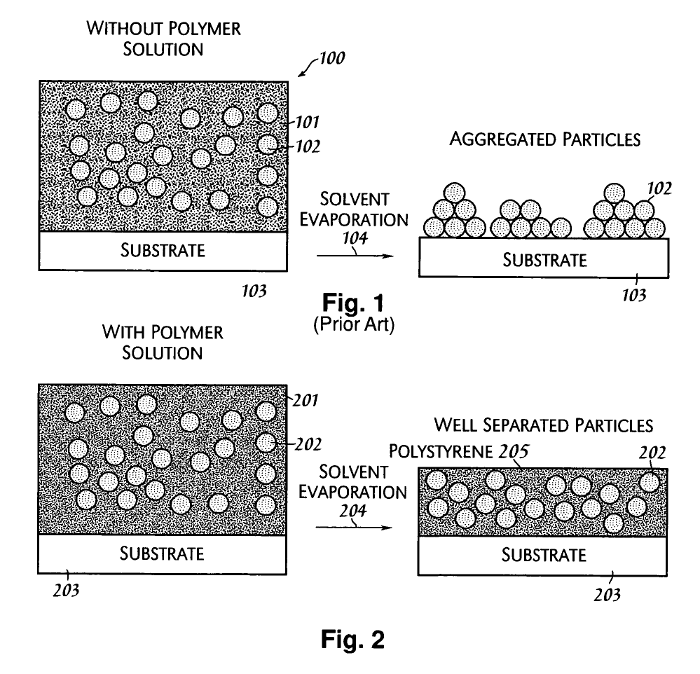

### DETAILED DESCRIPTION

In the following description, numerous specific details are set forth such as specific display configurations, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

Referring to FIG. 2, an organic polymer 201, such as polystyrene, is used to disperse Si nanoparticles 202. The polymer matrix 201 separates the Si nanoparticles 202 from each other, thus preventing them from aggregating to form larger particles or clusters.

In a particular embodiment, the procedure might occur as follows: 1.0 grams of polystyrene is dissolved in 100 milliliters (mL) of chloroform to form the polystyrene solution 201. 1.0 mL of this polystyrene solution 201 is then added to 9.0 mL of a silicon nanoparticles 202 solution. After the polystyrene/Si solution is casted on a substrate 203, the solvent is evaporated in step 204, resulting in a thin film of polystyrene 205 formed with Si nanoparticles 202 embedded within in a well separated manner, so that the Si nanoparticles 202 are not aggregated into clusters or clumps. The casting process is done by spraying the polystyrene/Si solution onto the substrate using a commercial airbrush. This process can also be done by other methods such as spin coating. The color of the polymer film may be white and show the same photoluminescent color as that from the Si nanoparticles solution before evaporation. The density of Si nanoparticles 202 can be adjusted by changing the concentration of the polystyrene solution 201. As a result, the present invention permits one to prepare and control the optical properties of solid state silicon nanoparticles-based materials.

Silicon nanoparticles of different sizes emit light with different wavelengths, or different colors, upon excitation by high-energy photon or electron beams. See M. V. Wolkin, Jorne, and P. M. Fauchet, Phys Rev Letts, 1999, 82, page 197, which is hereby incorporated by reference.

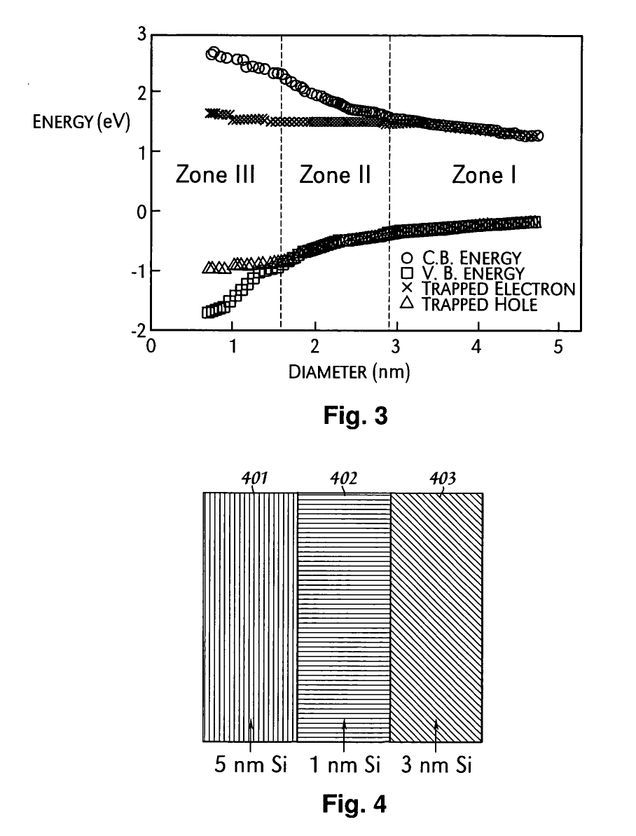

FIG. 3 illustrates the electronic states in Si nanoparticles where the energy gap between the valence band and the conduction band increases with decreasing nanoparticle size. As a result, nanoparticles with smaller diameters emit higher energy.

Si nanoparticles which emit red, blue and green color can be prepared in liquid phase. In display applications, a phosphor screen can then be prepared by patterning the substrate with these nanoparticles. FIG. 4 illustrates an exemplary “pixel” for such a display. For example, the red subpixel 401 may be created with five nanometer Si nanoparticles. The blue subpixel 402 may be created using one nanometer Si nanoparticles. The green subpixel 403 may be created using three nanometer Si nanoparticles. The pixel configuration illustrated in FIG. 4 could be used in any type of cathode ray tube, plasma, or field emission display. For example, FIG. 7 illustrates a portion of such a display apparatus where such subpixels are formed on a substrate, such as illustrated in FIG. 2, and then placed on a glass substrate 701 with an ITO layer 702. For example, the subpixel 703 could comprise one of the subpixels 401-403. To excite the Si nanoparticle polymer matrix 703 to emit light, UV light from cavity 705 containing a gas that emits UV light upon excitation with an electric field may be created within the substrate 704. An electrode 706 at the bottom of the cavity 705 may be used to produce the exciting field.

As discussed previously, these nanoparticles may aggregate to form clusters, which emit light at lower energy than that of the well-separated nanoparticles. The polymer matrix of the present invention would surround and coat each silicon nanoparticle and prevent the clusters from forming. This will make a photoluminescent spectrum of Si nanoparticles of such a phosphor as narrow as the photoluminescent spectrum of that comprising silicon nanoparticles defined by the width of the nanoparticles' size distribution. In other words, the designer may be able to more ably exhibit exact control over the wavelength of light emitted within each of the subpixels. Such a narrow photoluminescent spectra will enable the designer to achieve more saturated red, green and blue phosphor colors.

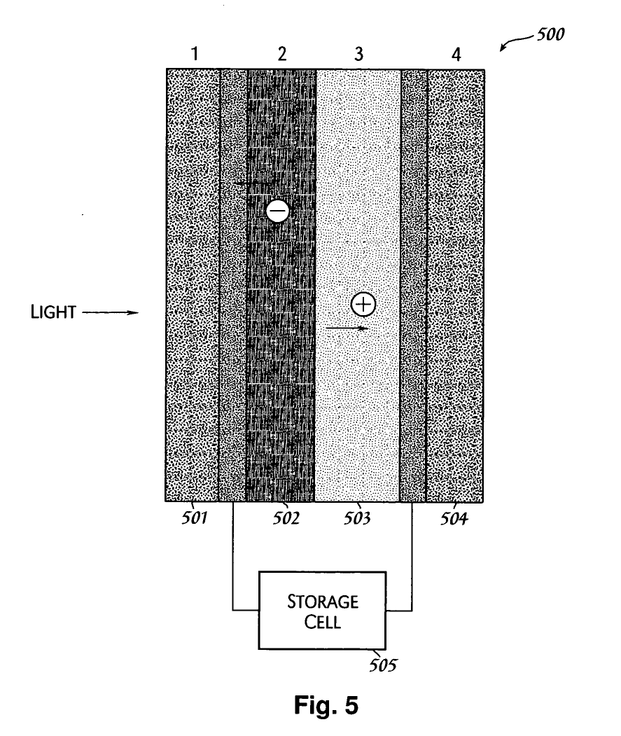

Referring next to FIG. 5, there is illustrated an alternative embodiment of the present invention where the polymer matrix described above with respect to FIG. 2 is applied within polymer solar cell technology. Polymer solar cells are known that comprise quantum dots and conducting polymers. Please refer to Quantum Dot Solar Cells, V. Aroutiounian, S. Petrosyan, A. Khachatryan, and K. Touryan, Yerevan State University, Armenia and The National Renewable Energy Laboratory in Golden, Colo., which is hereby incorporated by reference. Conducting polymer 503 may be a hole-conducting conjugated polymer, and the quantum dots 502 may be electron-conducting semiconductor nanoparticles, which in this instance, are Si nanoparticles in a polymer matrix as similarly described above with respect to FIG. 2. As light is incident upon the solar cell 500, an electron-hole pair is generated in the polymer 502. The electron-hole pair disassociates at the polymer-nanoparticle interface. The electrons are transported toward the solar cell cathode 501 by hopping over the nanoparticles. The holes are transported to the anode 504 through the conducting polymer 503. Si nanoparticles can be used within the polymer matrix 502 since the polymer helps prevent clusterization of the nanoparticles and promotes a better physical and electrical contact between greater amounts of Si nanoparticles, thus decreasing the series resistance over the nanoparticles and increasing solar cell power characteristics (fill factor). The fill factor of the solar cell is a product of short circuit (maximum) current by an open circuit (maximum) voltage. The short circuit current is a function of the internal resistance. The lower the resistance, the higher the ultimate current of the solar cell. The internal resistance, in turn, depends on the series resistance between nanoparticles. Thus, the more nanoparticles are in contact with each other, the lower the resistance, and, hence, the higher the maximum current and the fill factor.

The solar cell 500 can thus more efficiently store energy within the storage cell 505.

In another embodiment, such an organic polymer is introduced in addition to the silicon nanoparticle-conjugated polymer system. The conjugated polymer will provide the hole conductivity while the second polymer will prevent Si nanoparticles from clusterization.

In yet another embodiment, quantum dots are used to disassociate electron-whole excitations in one conducting polymer of the two. The first conducting polymer conducts holes to the solar cell anode and the second conducting polymer conducts electrons from the nanoparticle surface to the cathode. In one particular embodiment, silicon nanoparticles can be used as quantum dots in a solar cell, and one or both polymers will have a property to disperse silicon nanoparticles and prevent them from aggregation into clusters. In another embodiment, an organic polymer is introduced to the silicon nanoparticle-conjugated polymer system. The conjugated polymers will provide the electron and hole conductivities, while the third polymer will prevent Si nanoparticles from clusterization.

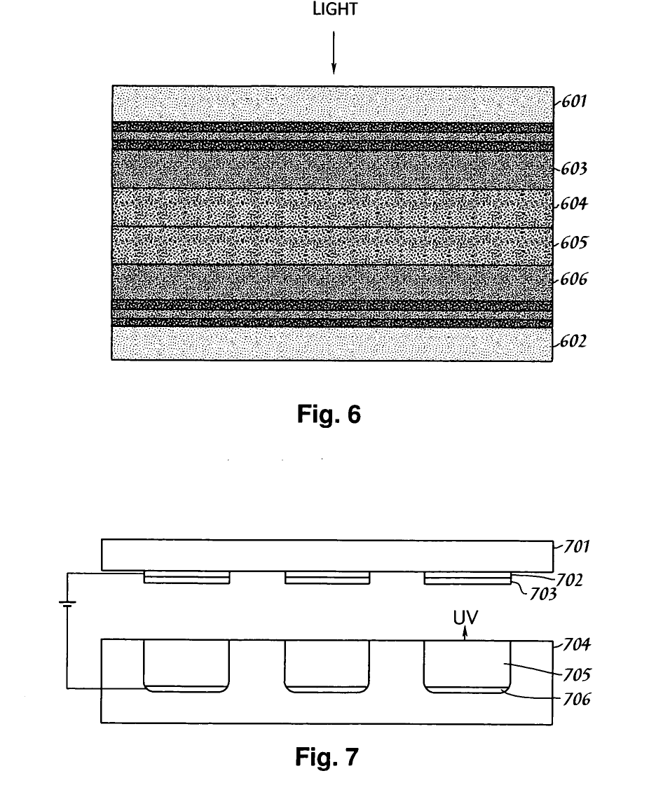

Referring to FIG. 6, a solar cell may comprise a system of two or more solar elements, each of which is a polymer-Si nanoparticle system described in the above embodiments. Such elements could have maximum conversion efficiency in a particular portion of the solar, or light, spectrum, defined by the optical properties of the nanoparticles, such as the spectral position of the optical absorption edge. A system of such elements where the absorption edges at different parts of the solar spectrum will cover the most parts of the solar spectrum for better conversion efficiency such that the element with the absorption edge in the shorter wave length range of the spectrum could be located upward towards the incident solar light. Thus, the cathode 601 and anode 602 could sandwich different polymer-Si nanoparticle systems 603-606, each having different absorption edges for different portions of the solar or light spectrum.

Although the present invention and its advantages have been described in detail, it should be understood that various changes, substitutions and alterations can be made herein without departing from the spirit and scope of the invention as defined by the appended claims.

What is claimed is:

1. A material comprising at least two nanoparticles dispersed in a polymer matrix.

2. The material as recited in claim 1, wherein the nanoparticles are silicon nanoparticles.

3. The material as recited in claim 1, wherein the polymer matrix prevents the at least two nanoparticles from aggregating.

4. The material as recited in claim 2, wherein the polymer matrix prevents the at least two nanoparticles from aggregating.

5. A method comprising the steps of:
adding a nanoparticles solution to a polystyrene and chloroform solvent;
casting the combined solutions on a substrate;
evaporating the solvent leaving a film of polystyrene formed with the nanoparticles embedded therein.

6. The method as recited in claim 5, wherein the nanoparticles are silicon nanoparticles.

7. The method as recited in claim 5, wherein the nanoparticles are dispersed in the film in a non-aggregated manner.

8. A display apparatus comprising:
a pixel element comprising a phosphor of at least two silicon nanoparticles dispersed in a polymer matrix.

9. The display apparatus as recited in claim 8, wherein the at least two silicon nanoparticles are dispersed in the polymer matrix in a non-aggregated manner.

10. The display apparatus as recited in claim 9, wherein the pixel element further comprises first and second subpixel elements, wherein the first subpixel element comprises silicon nanoparticles of a first diameter size selected to emit light of a first wavelength, and wherein the second subpixel element comprises silicon nanoparticles of a second diameter size selected to emit light of a second wavelength different than the first wavelength.

11. The display apparatus as recited in claim 10, further comprising:
a cavity containing a gas that emits ultraviolet light when energized by an electric field, the ultraviolet light bombarding the pixel element to cause emission of visible light from the silicon nanoparticles.

12. A photovoltaic cell comprising:
an anode;
a cathode;
a conducting polymer layer adjacent the anode; and
a polymer/silicon nanoparticles layer comprising silicon nanoparticles dispersed within a polymer matrix, the polymer/silicon nanoparticles layer adjacent the cathode and the conducting polymer layer.

13. The photovoltaic cell as recited in claim 12, wherein the conducting polymer layer comprises a conjugated polymer.

14. The photovoltaic cell as recited in claim 12, further comprising a storage cell coupled to the anode and the cathode.

15. A photovoltaic cell comprising:
an anode;
a cathode;
a first polymer/silicon nanoparticles layer adjacent the anode and having a first optical absorption edge; and
a second polymer/silicon nanoparticles layer adjacent the cathode and having a second optical absorption edge different than the first optical absorption edge.

16. The photovoltaic cell as recited in claim 15, wherein the first and second polymer/silicon nanoparticles layers absorb light at different wavelengths.
